(19) United States
(12) Patent Application Publication
(10) Pub. No.: US 2020/0409580 A1
(43) Pub. Date: Dec. 31, 2020

(54) DATA STORAGE DEVICE, A METHOD OF OPERATING THE SAME, AND A CONTROLLER FOR THE SAME

(71) Applicant: SK hynix Inc., Gyeonggi-do (KR)

(72) Inventor: Eu Joon BYUN, Gyeonggi-do (KR)

(21) Appl. No.: 16/690,496

(22) Filed: Nov. 21, 2019

(30) Foreign Application Priority Data
Jun. 28, 2019 (KR) 10-2019-0077687

(51) Int. Cl. G06F 3/06

(52) U.S. Cl. CPC G06F 3/0634; G06F 3/0616; G06F 3/064; G06F 3/0659; G06F 3/0673

(57) ABSTRACT

A data storage device may include a storage and a controller. The storage may include a plurality of memory blocks. Each of the memory blocks may include a plurality of memory cells. The storage may have storage modes determined by bit numbers of data storable in a unit memory cell. The controller may communicate with the storage. The controller may change the storage modes of a memory block, which may have a lifespan reaching to a predetermined threshold value, among the memory blocks. The controller may register the memory block having the changed storage mode in a mode change block list. When generating a block allocation event, the controller may calculate a storage capacity of a memory block in accordance with whether the allocated memory block may be registered in the mode change block list. The controller may allocate the memory block in accordance with the calculated storage capacity and a size of processed data.

### CROSS-REFERENCES TO RELATED APPLICATION

The present application claims priority under 35 U.S.C. § 119(a) to Korean application number 10-2019-0077687, filed on Jun. 28, 2019, which is incorporated herein by reference in its entirety.

### BACKGROUND

### 1. Technical Field

Various embodiments may relate to a semiconductor integrated device, more particularly, a data storage device, a method of operating the data storage device, and a controller for the data storage device.

### 2. Related Art

A data storage device may be electrically connected with a host device to perform data input/output operations in accordance with requests of the host device. In order to store data, the data storage device may use at least one of various storage media.

For example, the data storage device may include a non-volatile memory device such as a flash memory device working as a storage medium. As a storage capacity and a cost of the flash memory device may have been improved in accordance with developments of the flash memory device, a data center for processing massive data as well as a personal computer, a mobile device, and etc., may use or embed the data storage device including the flash memory.

The flash memory device may not overwrite bits or bytes of data simply, as with a volatile memory device or a magnetic disc. Further, the flash memory device may have a unit of nonvolatile memory cells read or written together (e.g., a page), which is distinguishable or different from another unit of nonvolatile memory cells erased together (e.g., a memory block). The flash memory device may have a limited lifespan estimated through program/erase cycles.

A lifespan of the flash memory device may be limited due to the above-mentioned characteristics. Therefore, it may be required to ensure reliability of the flash memory device.

### SUMMARY

In example embodiments of the present disclosure, a data storage device comprising: a storage including a plurality of memory blocks, each of the memory blocks including a plurality of memory cells, wherein each of the memory blocks has a storage mode determined in accordance with bit numbers of data storable in the memory cell; and a controller configured to communicate with the storage to change a storage mode of a memory block, which has a lifespan reaching a predetermine threshold value, among the memory blocks, to register the memory block having the changed storage mode in a mode change block list, to calculate a storage capacity of a memory block allocated by a block allocation event based on whether the allocated memory block is registered in the mode change block list, and to use the memory block in accordance with the calculated storage capacity and a size of processed data.

In example embodiments of the present disclosure, according to a method of operating a data storage device, the data storage device may include a storage and a controller. The storage may include a storage including a plurality of memory blocks, each of the memory blocks including a plurality of memory cells, wherein each of the memory blocks has a storage mode determined in accordance with bit numbers of data storable in the memory cell, and a controller communicated with the storage, the method comprising: detecting a memory block having a lifespan, which reaches a predetermined threshold value, among the memory blocks by the controller; changing a storage mode of the detected memory block by the controller; registering the memory block having the changed storage mode in a mode change block list by the controller; and allocating the memory block by the controller at a block allocation event in accordance with whether the allocated memory block is in the mode change block list and a size of processed data.

In example embodiments of the present disclosure, a memory system, comprising: a non-volatile storage including a plurality of memory blocks, each memory block including a plurality of memory cells; and a controller configured to determine a storage mode indicating how many bit data is stored in a memory cell, based at least on a parameter including usage count regarding a memory block including the memory cell, calculate a storage capacity of the memory block based on the storage mode, and notify the storage capacity to an external device.

### BRIEF DESCRIPTION OF THE DRAWINGS

The above and another aspect, features and advantages of the subject matter of this disclosure will be more clearly understood from the following detailed description taken in conjunction with the accompanying drawings, in which:

FIG. 1 shows a data storage device in accordance with an embodiment;

FIG. 2 illustrates a storage in accordance with an embodiment;

FIG. 3 describes a controller in accordance with an embodiment;

FIG. 4 shows a block management component in accordance with an embodiment;

FIG. 5 describes a block attribute in accordance with an embodiment;

FIG. 6 describes a lifespan management concept of a block in accordance with an embodiment;

FIG. 7 shows a block management concept in accordance with an embodiment;

FIGS. 8 and 9 are flow charts illustrating a method of operating a data storage device in accordance with an embodiment;

FIG. 10 is a diagram illustrating a data storage system in accordance with an embodiment;

FIGS. 11 and 12 are diagrams illustrating a data processing system in accordance with an embodiment;

FIG. 13 is a diagram illustrating a network system including a data storage device in accordance with an embodiment; and

FIG. 14 is a diagram illustrating a nonvolatile memory device included in a data storage device in accordance with an embodiment.

### DETAILED DESCRIPTION

Various embodiments of this disclosure will be described in greater detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of this invention as defined in the appended claims.

An embodiment of this disclosure is described herein with reference to cross-section and/or plan illustrations. However, embodiments of this invention should not be construed as limiting the inventive concept. Although a few embodiments of this disclosure will be shown and described it will be appreciated by those of ordinary skill in the art that changes may be made in these embodiments without departing from the principles and spirit of this invention.

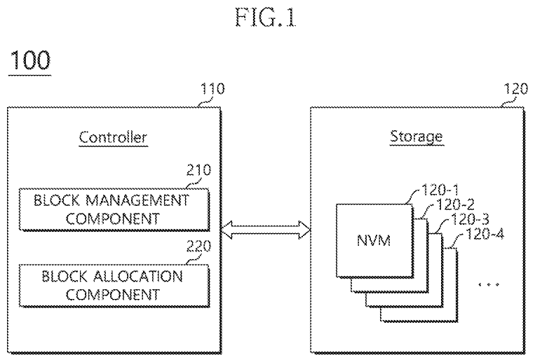

FIG. 1 is a view illustrating a data storage device in accordance with an embodiment.

Referring to FIG. 1, a data storage device 100 according to an embodiment may include a controller 110 and a storage 120.

The controller 110 may be communicated with the storage 120. The controller 110 may write data transmitted from a host device in the storage 120 or transmit data read from the storage 120 to the host device. The controller 110 may control various operations for managing the storage 120, regardless of a request inputted from the host device.

The storage 120 may include a volatile memory device or a non-volatile memory device. In an embodiment, the storage 120 may include a memory device selected from various non-volatile memory devices such as an electrically erasable and programmable ROM (EEPROM), a NAND flash memory, a NOR flash memory, a phase change RAM (PRAM), a resistive RAM (ReRAM), a ferroelectric RAM (FRAM), a spin torque transfer magnetic RAM (STT-MRAM), and etc. In an embodiment, the storage 120 may include a plurality of the non-volatile memory devices NVM 120-1, 120-2, 120-3, 120-4.

Each of the non-volatile memory devices NVM 120-1, 120-2, 120-3, 120-4 may include a plurality of dies, a plurality of chips, or a plurality of packages. Each of the dies, the chips, or the packages may include a plurality of memory blocks.

The storage 120 may include a single level cell for storing one-bit data, or a multi-level cell for storing multi-bit data based on a multi-leveling technology.

The multi-leveling technology may support storing the multi-bit data in a single flash memory cell. An XLC cell, which may be developed from the single level cell based on the multi-leveling technology, includes one of the multi-level cell (MLC) for storing two-bit data in one cell, a triple-level cell (TLC) for storing three-bit data in one cell, or a quad-level cell (QLC) for storing four-bit data in one cell. Bit numbers storable in a unit cell may be increased to improve an efficiency of storage capacity in a flash memory device.

A storage including the XLC cell may have a capacity of about 2^{(x-1)} times more than a capacity of a storage including the SLC cell. However, the XLC cell may have a lower performance and a shorter lifespan than those of the SLC cell. The lifespan of the XLC cell may be inversely proportional to the storable bit numbers in a single cell.

The storage 120 may have a specific storage mode, i.e., a way for storing data, for showing how many bit data can be programmed in a single cell.

The controller 110 may include a block management component 210 and a block allocation component 220.

The block management component 210 may recognize, control, or manage a physical address of each of the memory blocks in the storage 120 and usage states of the memory blocks.

When the usage states of the memory block in the storage 120 may be changed, for example, the memory block may be released, the block management component 210 may check a lifespan of the released memory block. When a lifespan of a specific memory block may reach to a predetermined threshold value, the block management component 210 may change the usage state of the specific memory block. In an embodiment, the release of the memory block may mean that all of data remained in the memory block may be invalidated and the memory block may be registered as an available block for a new program operation.

In an embodiment, the block management component 210 may change a current storage mode regarding the memory block, which may have a lifespan reaching to the threshold value, into a low level storage mode for storing less-bit data than those of the current storage mode. For example, when the current storage mode of the memory block may be an XLC storage mode for storage X-bit data and the memory block may reach to the predetermined threshold value, the current storage mode of the memory block may be changed into a storage mode for storing less-bit data than the XLC storage mode, for example, for storing (X−I)-bit data. The ‘I’ may be a positive integer less than the X.

The block management component 210 may use a mode change block list to control or manage the memory blocks having the changed storage modes.

When the storage mode of the memory block having an estimated lifespan reaching to the threshold may be changed, a total capacity of the storage 120 may also be adjusted. The block management component 210 may calculate or adjust the total capacity of the storage 120. The block management component 210 may then notice the calculated total capacity to the host device. Thus, the host device may adjust an available storage capacity provided from the data storage device 100.

When an event of allocating a memory block may occur in response to a write request inputted from the host device or a background operation performed in the storage 120, the block allocation component 220 may check whether the allocated memory block may be included in the mode change block list. The block allocation component 220 may allocate a memory block having an available space corresponding to a size of processed data, based on the change of storage mode regarding the allocated memory block.

In an embodiment, the event of allocating a memory block may include an operation for allocating an open block required for processing the write request inputted from the host device or the background operation performed in the storage 120. Further, the event for allocating a memory block may include an operation for allocating any one of free blocks for a following program operation when any open block may not exist.

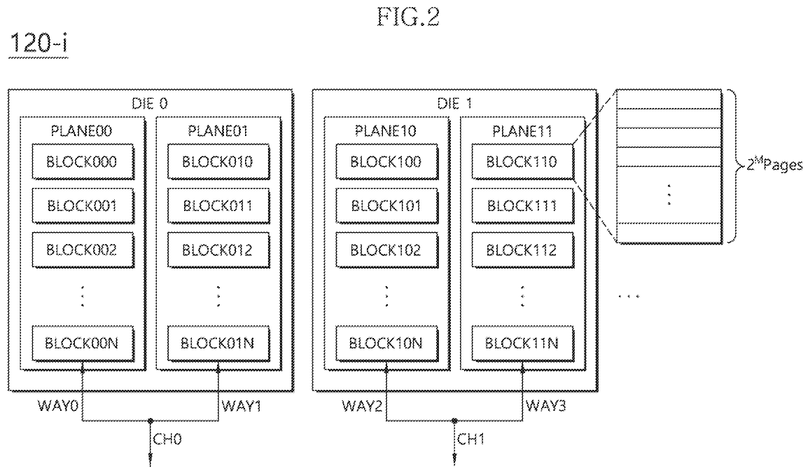

FIG. 2 is a view illustrating a storage in accordance with an embodiment.

Referring to FIG. 2, the storage 120 may include a plurality of non-volatile memory devices 120-i. Each of the non-volatile memory devices 120-i may include a plurality of memory dies DIE0, DIE1. Each of the dies DIE0, DIE1 may include a plurality of planes PLANE00, PLANE01, PLANE10, PLANE11. Each of the planes PLANE00, PLANE01, PLANE10, PLANE11 may include a plurality of memory blocks BLOCK000 to BLOCK00N, BLOCK010 to BLOCK01N, BLOCK100 to BLOCK10N, BLOCK110 to BLOCK11N.

Each of the memory blocks BLOCK000 to BLOCK00N, BLOCK010 to BLOCK01N, BLOCK100 to BLOCK10N, BLOCK110 to BLOCK11N may include a plurality of pages, for example, 2^{M} numbers of pages.

The planes PLANE00, PLANE01, PLANE10, PLANE11 in each of the memory dies DIE0, DIE1 may input/output data through channels CH0, CH1 and a plurality of ways WAY0, WAY1. By the way of example but not limitation, FIG. 2 shows the two ways commonly sharing one channel.

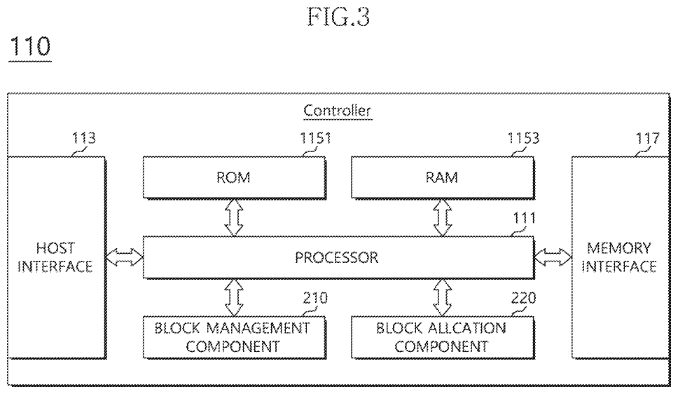

FIG. 3 is a view illustrating a controller in accordance with an embodiment.

Referring to FIG. 3, the controller 110 may include a processor 111, a host interface 113, a ROM 1151, a RAM 1153, a memory interface 117, the block management component 210, and the block allocation component 220.

The processor 111 may provide the controller 110 with various functions for managing the storage 120. For example, the processor 111 may control the host interface 113 and the memory interface 117 to perform a read operation or a write operation provided from the host device. The processor 111 may include a micro-processor or a central processing unit (CPU) including a hardware and a software performed by the hardware.

The processor 111 may transmit various control information, which may be required for a read operation or a write operation of data with respect to the storage 120, to the host interface 113, the RAM 1153 and the memory interface 119. In an embodiment, the processor 111 may be operated in accordance with firmwares provided for various operations of the data storage device 100. The processor 111 may include a structure combined a hardware with a software implementing in the hardware to perform a function of a flash translation layer (FTL) including various functions for managing the storage 120.

The FTL may have a function for providing a garbage collection, an address mapping, a wear leveling, etc., a function for managing properties of each of memory blocks in the storage 120. The FTL may have an ECC (error check and correction) function for detecting and correcting errors read from the storage 120.

The host interface 113 may provide an interface between the host device and the data storage device 100. The host interface 113 may receive, store and schedule commands and clock signals from the host device. The host interface 113 may provide the processor 111 with the scheduled commands and clock signals. The host interface 113 may provide the memory interface 117 with write data provided from the host device or the host device with data provided from the storage 120 through the memory interface 117 in accordance with controls of the processor 111.

Particularly, the host interface 113 may provide a physical connection between the host device and the data storage device 100. The host interface 113 may be interfaced with the data storage device 100 corresponding to a bus format of the host device. The bus format of the host device may include at least one of standard interface protocols such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small component interconnection (PCI), a PCI express (PCI-E), a universal flash storage (UFS), etc.

The memory interface 117 may transmit the data provided from the host interface 113 to the storage 120 or the data read from the storage 120 to the host interface 113 by the controls of the processor 111. Thus, the memory interface 117 may provide communication channels through which signals may be transmitted between the controller 110 and the storage 120.

The ROM 1151 may store program codes such as a firmware or a software required for operating the controller 110, and code data used by the program codes.

The RAM 1153 may store data required for operating the controller 110 and data generated by the controller 110.

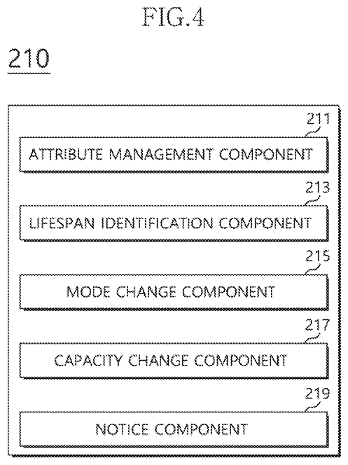

FIG. 4 is a view illustrating a block management component in accordance with an embodiment.

Referring to FIG. 4, the block management component 210 may include an attribute management component 211, a lifespan identification component 213, a mode change component 215, a capacity change component 217 and a notice component 219.

The attribute management component 211 may manage the usage state corresponding to physical addresses of the memory blocks in the storage 120.

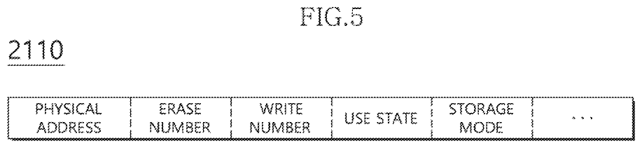

FIG. 5 is a view illustrating a block attribute in accordance with an embodiment.

Referring to FIG. 5, a block attribute 2110 may include an erase count, a program count, a usage state and a storage mode corresponding to the physical addresses.

The erase count and the program count may be renewed when an erase operation or a write operation may be performed on the memory block. A re-write count (e.g., a program/erase (P/E) cycle) defined by the erase count or the program count of the memory block may be increased to show that electrical stresses applied to the memory cell may be increased. The memory cell erased or written over a predetermined number of times may not be reliably used. Thus, the memory cell and the memory block including the memory cell may have a limited erase count or a limited re-write count. The lifespan of the memory block may be determined based on the limited erase count or the limited program count.

The usage state may include information representing whether the memory block may be allocated.

The storage mode may include information representing a current storage mode of a corresponding memory block, i.e., a storage capacity of the corresponding memory block, for indicating how many bits of data could be stored in a nonvolatile memory cell of the corresponding memory block.

The lifespan identification component 213 may identify a lifespan of a corresponding memory block when the use state of the corresponding memory block may be changed. In an embodiment, the lifespan identification component 213 may identify a lifespan of an allocated memory block when the allocated memory block may be released.

When the lifespan of the memory block may reach to the threshold value based on the block attribute, the mode change component 215 may change the storage mode of the corresponding memory block.

In an embodiment, the lifespan identification component 213 may determine the lifespan of the release memory block based on the erase count or the re-write count of the release memory block and the predetermined threshold number.

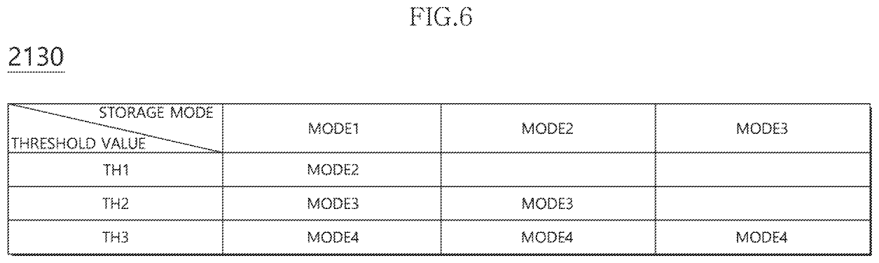

FIG. 6 is a view illustrating a lifespan management concept of a block in accordance with an embodiment.

Referring to FIG. 6, the mode change component 215 may provide the storage mode of the storage 120 with a plurality of modes 1-4. In an embodiment, the mode 1 may correspond to the QLC storage mode, the mode 2 may correspond to the TLC storage mode, the mode 3 may correspond to the MLC storage mode, and the mode 4 may correspond to the SLC storage mode, not restricted within the above-mentioned correspondence.

In order to determine the lifespan of the memory block, the mode change component 215 may manage first to third threshold numbers TH1, TH2, TH3 based on an erase count or the re-write count by the storage mode.

The first threshold value TH1 may correspond to a value at which the memory block of the QLC storage mode (mode 1) may be operated by a low level of no more than the TLC, not by the QLC.

The second threshold value TH2 may correspond to a value at which the memory block of the TLC storage mode (mode 2) may be operated by a low level of no more than the MLC, not by the TLC.

The third threshold value TH3 may correspond to a value at which the memory block of the MLC storage mode (mode 3) may be operated by the SLC, not by the MLC.

A lookup table shown in FIG. 6 may be stored in the block management component 210. The lifespan identification component 213 may identify the lifespan of the corresponding memory block based on the predetermined threshold value in accordance with a current storage mode of the released memory block. In an embodiment, the lifespan identification component 213 may determine whether an erase count or the rewrite count of the released memory block operated in a specific storage mode may reach to the predetermined threshold value, in order to check and recognize the lifespan of the corresponding memory block.

When a current storage mode of the memory block having the lifespan reaching to the threshold value may be an XLC storage mode configured to store Y bits of data, the mode change component 215 may change the current storage mode into a storage mode for storing less-bit data than the XLC, for example, for storing (Y−I) bits of data. The I may be an integer number less than the Y.

In an embodiment, the mode change component 215 may manage the memory blocks having the changed storage modes using an additional mode change block list.

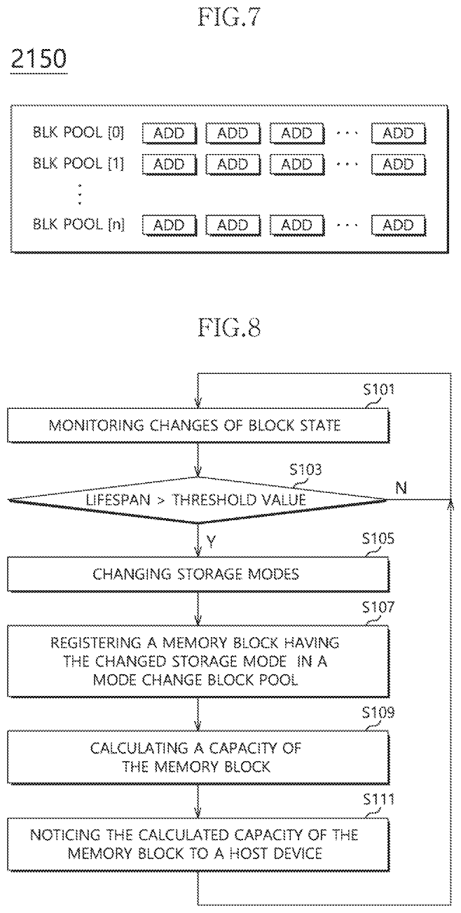

FIG. 7 is a view illustrating a block management concept in accordance with an embodiment.

Referring to FIG. 7, a mode change block list 2150 may store an address ADD of a memory block, which may have a lifespan reaching to the threshold value and have a changed storage mode.

The mode change block list 2150 may include a block pool BLK POOL [0:1] by changed storage modes.

In an embodiment, the first block pool BLK POOL [0] may manage addresses ADD of the memory blocks having the changed storage mode 2. The second block pool BLK POOL [1] may manage addresses ADD of the memory blocks having the changed storage mode 3. The third block pool BLK POOL [2] may manage addresses ADD of the memory blocks having the changed storage mode 4.

In an embodiment, the numbers of the block pools may be changed in accordance with numbers of the storage modes.

The storage mode of the memory block reaching the lifespan limit may be changed to change the total capacity of the storage 120. The capacity change component 27 may calculate a changed capacity of the storage 120.

In an embodiment, when a number of bits storable in the memory cell may be K, a capacity of a unit memory cell may be 2^{(K-1)} The capacity of the memory block having the changed storage mode may be calculated in accordance with numbers of the pages in each of the memory blocks and numbers of the cell in each of the pages. The total capacity of the storage 120 may be calculated based on the changed capacity of the memory block having the changed storage mode.

The notice component 219 may notice the changed capacity of the memory block calculated by the capacity change component 217 to the host device. Thus, the host device may adjust the capacity of the data storage device 100.

Referring again to FIG. 3, when an event for allocating the memory block may be generated by the request of the host device or the background operation of the storage 120, the block allocation component 220 may check whether the allocated block may be included in the mode change block list. The block allocation component 220 may assign a following operation to the memory block coincided with a size of data processed, based on the mode change of the allocated block.

In an embodiment, a block allocation event may be generated in response to the write request of the host device.

In an embodiment, the block allocation event may be generated in response to the garbage collection of the data storage device 100, the background operations such as a read reclaim, a read rewrite, a migration, etc.

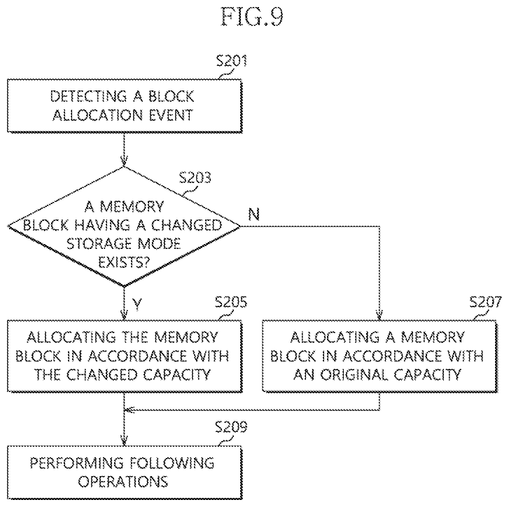

FIGS. 8 and 9 are flow charts illustrating a method of operating a data storage device in accordance with an embodiment.

FIG. 8 is a flow chart illustrating a method of managing a memory block in accordance with an embodiment.

Referring to FIG. 8, in a step S101, the block management component 210 may monitor the change of attributes regarding memory blocks during the operation of the data storage device 100.

In a step S103, when a specific block may be released while the attributes of the memory blocks are monitored, the block management component 210 may determine whether a lifespan of the released memory block may reach to the threshold value.

In an embodiment, the block management component 210 may identify an erase count or a program count of the release memory block may be beyond a threshold value.

When the lifespan of the released memory block may not reach to the threshold value (No in the S103), the attributes of the memory blocks may be continuously monitored (go back to the step S101).

When the lifespan of the released memory block may reach to the threshold value (Yes in the S103), in a step S105, the block management component 210 may change the storage mode of the released memory block based on the lifespan of the memory block and the threshold value.

In an embodiment, as shown in FIG. 6, plural threshold values or ranges may be set according to plural storage modes. The current storage mode of the corresponding memory block may be changed into another storage mode when the erase count or the program count of the released memory block is greater than a threshold value.

In a step S107, the memory block having the changed storage mode may be registered in the mode change block list corresponding to the changed storage mode.

The number of bit of data storable in unit cells of the memory block having a changed storage mode may be changed so that storage capacity of the storage 120 may also be adjusted. Thus, in a step S109, the block management component 210 may calculate the storage capacity of the memory block in accordance with the changed storage mode. In a step S111, the block management component 210 may notify the calculated capacity of the memory block to the host device.

FIG. 9 is a flow chart illustrating a method of allocating a memory block in accordance with an embodiment.

Referring to FIG. 9, in a step S201, the block allocation event is detected. Herein, the block allocation event may be generated in response to the request of the host device or the background operations. For example, in response to the block allocation event, a memory block is allocated for a following operation performed by the controller.

In a step S203, the block allocation component 220 may check whether the allocated memory block may be in the mode change block list.

The memory block registered in the mode change block list may have a lower storage capacity than the original storage capacity. Thus, in a step S205, the block allocation component 220 may recognize that the allocated memory block has a changed storage capacity. The block allocation component 220 may determine which operation is assigned to the allocated memory block based on the changed storage capacity and a size of data involved in an operation.

When the memory block may be not registered in the mode change block list, the memory block may keep the original storage capacity. Thus, in a step S207, the block allocation component 220 may assign the memory block to a following operation based on the original storage capacity and the size of the processed data.

In a step S209, after allocating the memory block and recognizing its storage capacity, the following operation corresponding to the request for allocating the memory block may be performed.

According to an embodiment, the electrical stresses applied to the memory block having the lifespan reaching the limit may be reduced to extend the lifespans of the storage 120 and the data storage device 100, thereby improving reliability of the data storage device.

Further, the memory block having the changed storage mode may be registered and controlled in the additional block pool to smoothly manage the capacity change of the memory block in accordance with the storage mode change.

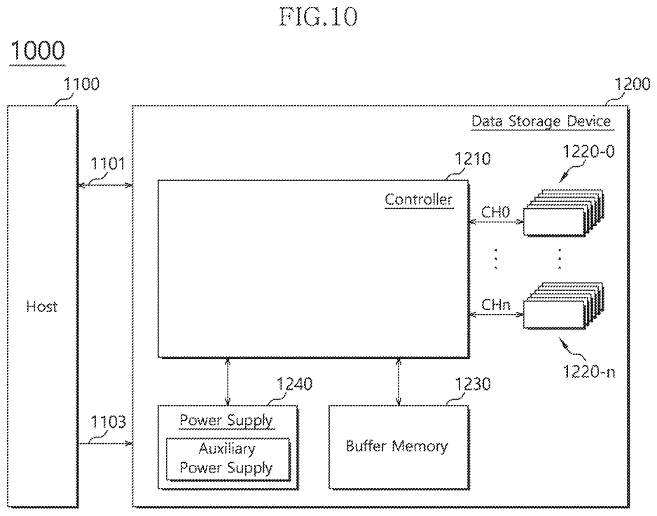

FIG. 10 is a diagram illustrating a data storage system 1000, in accordance with an embodiment.

Referring to FIG. 10, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface unit, a control unit, a random access memory used as a working memory, an error correction code (ECC) unit, and a memory interface unit. In an embodiment, the controller 1210 may configured as controller 110 shown in FIGS. 1 to 4.

The host device 1100 may exchange a signal with the data storage device 1200 through the signal connector 1101. The signal may include a command, an address data, and so forth.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be normally terminated when a sudden power interruption occurs. The auxiliary power supply may include bulk-capacity capacitors sufficient to store the needed charge.

The signal connector 1101 may be configured as one or more of various types of connectors depending on an interface scheme between the host device 1100 and the data storage device 1200.

The power connector 1103 may be configured as one or more of various types of connectors depending on a power supply scheme of the host device 1100.

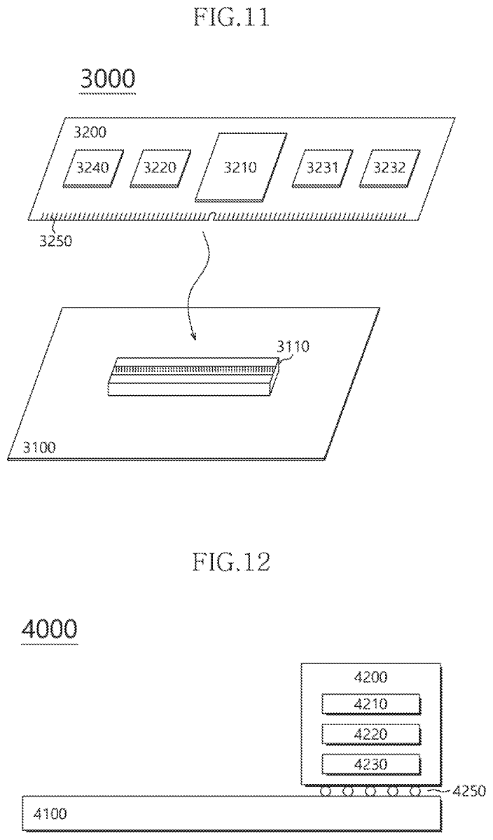

FIG. 11 is a diagram illustrating a data processing system 3000, in accordance with an embodiment. Referring to FIG. 11, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231, 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 to 4.

The buffer memory device 3220 may temporarily store data to be stored in the nonvolatile memory devices 3231, 3232. Further, the buffer memory device 3220 may temporarily store data read from the nonvolatile memory devices 3231, 3232. The data temporarily stored in the buffer memory device 3220 may be transmitted to the host device 3100 or the nonvolatile memory devices 3231, 3232 according to control of the controller 3210.

The nonvolatile memory devices 3231, 3232 may be used as storage media of the memory system 3200.

The PMIC 3240 may provide the power inputted through the connection terminal 3250 to the inside of the memory system 3200.

The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and so forth, and power may be transferred between the host device 3100 and the memory system 3200. The connection terminal 3250 may be configured as one or more of various types depending on an interface scheme between the host device 3100 and the memory system 3200. The connection terminal 3250 may be disposed on a side of the memory system 3200, as shown.

FIG. 12 is a diagram illustrating a data processing system 4000 in accordance with an embodiment. Referring to FIG. 12, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 and 2.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

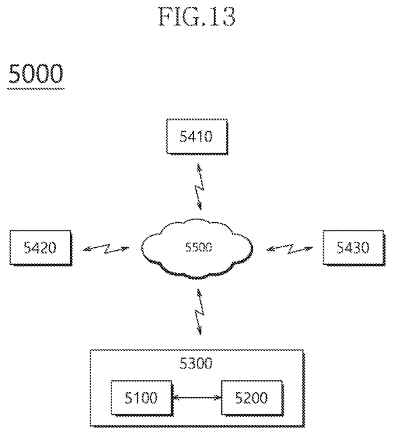

FIG. 13 is a diagram illustrating a network system 5000 including a data storage device, in accordance with an embodiment. Referring to FIG. 13, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 10, the memory system 3200 shown in FIG. 11, or the memory system 4200 shown in FIG. 12.

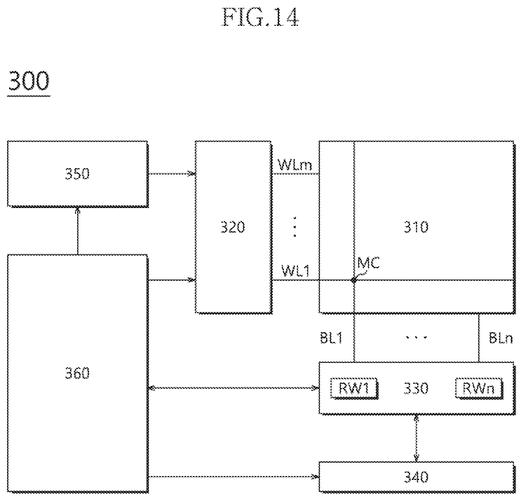

FIG. 14 is a block diagram illustrating a nonvolatile memory device 300 included in a data storage device, such as the data storage device 10, in accordance with an embodiment. Referring to FIG. 14, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array, for example, has a stacked structure by perpendicular direction to the flat surface of a semiconductor substrate. Moreover, the three-dimensional memory array means a structure including NAND strings which memory cells comprised in NAND strings are stacked perpendicular to the flat surface of a semiconductor substrate.

The structure of the three-dimensional memory array is not limited to the embodiment indicated above. The memory array structure can be formed in a highly integrated manner with horizontal directionality as well as vertical directionality. In an embodiment, in the NAND strings of the three-dimensional memory array memory cells are arranged in the horizontal and vertical directions with respect to the surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided by the external device. For example, the control logic 360 may control operations of the nonvolatile memory device 300 such as read, write, and erase operations of the nonvolatile memory device 300.

The above described embodiments of the present invention are intended to illustrate and not to limit the present invention. Various alternatives and equivalents are possible. The invention is not limited by the embodiments described herein. Nor is the invention limited to any specific type of semiconductor device. Another addition, subtractions, or modifications are obvious in view of the present disclosure and are intended to fall within the scope of the appended claims.

What is claimed is:

1. A data storage device comprising:
a storage including a plurality of memory blocks, each of the memory blocks including a plurality of memory cells, wherein each of the memory blocks has a storage mode determined in accordance with bit numbers of data storable in the memory cell; and
a controller configured to communicate with the storage to change a storage mode of a memory block, which has a lifespan reaching a predetermine threshold value, among the memory blocks, to register the memory block having the changed storage mode in a mode change block list, to calculate a storage capacity of a memory block allocated by a block allocation event based on whether the allocated memory block is registered in the mode change block list, and to use the memory block in accordance with the calculated storage capacity and a size of processed data.

2. The data storage device of claim 1, wherein the controller changes the storage mode to decrease the bit numbers of data storable in the memory cell.

3. The data storage device of claim 1, wherein the controller calculates a capacity of the storage in accordance with the change of the storage mode, and the controller notifies the calculated capacity to a host device.

4. The data storage device of claim 1, wherein, when the memory block is released, the controller checks the lifespan of the released memory block and the controller changes the storage mode.

5. The data storage device of claim 1, wherein the block allocation event comprises an event for allocating an open block for processing a write request of a host device or a background operation of the controller, or an event for opening and allocating any one of free blocks when the open block does not exit.

6. The data storage device of claim 1, wherein the lifespan is determined based on an erase count or a re-write count of the memory block.

7. The data storage device of claim 1, wherein the controller sets and stores threshold values corresponding to the storage modes, based on an erase number or a re-write count of the memory block with respect to each of the storage modes.

8. The data storage device of claim 7, wherein the storage modes comprise a first mode for storing four-bit data in the memory cell, a second mode for storing three-bit data in the memory cell, a third mode for storing two-bit data in the memory cell, and a fourth mode for storing one-bit data in the memory cell.

9. The data storage device of claim 8, wherein the threshold value comprises a first threshold value for determining whether the memory block operates in the second mode, a second threshold value for determining whether the memory block operates in the third mode, or a third threshold value for determining whether the memory block operates in the fourth mode.

10. The data storage device of claim 8, wherein the threshold value comprises a second threshold value for determining whether the memory block operates in the third mode, or a third threshold value for determining whether the memory block operates in the fourth mode.

11. The data storage device of claim 8, wherein the threshold value comprises a third threshold value for determining whether the memory block operates in the fourth mode.

12. A method of operating a data storage device, the data storage device including a storage including a plurality of memory blocks, each of the memory blocks including a plurality of memory cells, wherein each of the memory blocks has a storage mode determined in accordance with bit numbers of data storable in the memory cell, and a controller communicated with the storage, the method comprising:
detecting a memory block having a lifespan, which reaches a predetermined threshold value, among the memory blocks by the controller;
changing a storage mode of the detected memory block by the controller;
registering the memory block having the changed storage mode in a mode change block list by the controller; and
allocating the memory block by the controller at a block allocation event in accordance with whether the allocated memory block is in the mode change block list and a size of processed data.

13. The method of claim 12, wherein changing the storage mode comprises decreasing bit numbers of the data storable in the memory cell.

14. The method of claim 12, further comprising:
calculating a capacity of the storage in accordance with the change of the storage mode by the controller; and
notifying the calculated capacity to a host device by the controller.

15. The method of claim 12, wherein detecting the lifespan of the memory block further comprises checking a lifespan of a released memory block when the memory block is released.

16. The method of claim 12, wherein the block allocation event comprises an event for allocating an open block for processing a write request of a host device or a background operation of the controller, or an event for opening and allocating any one of free blocks when the open block does not exit.

17. The method of claim 12, wherein the lifespan is determined based on an erase count or a re-write count of the memory block.

18. The method of claim 12, wherein the controller sets and stores threshold values corresponding to the storage modes, based on an erase count or a re-write count of the memory block with respect to each of the storage modes.

19. The method of claim 18, wherein the storage modes comprise a first mode for storing four-bit data in the memory cell, a second mode for storing three-bit data in the memory cell, a third mode for storing two-bit data in the memory cell, and a fourth mode for storing one-bit data in the memory cell, and
wherein the threshold value comprises a first threshold value for determining whether the memory block operates in the second mode, a second threshold value for determining whether the memory block operates in the third mode, or a third threshold value for determining whether the memory block operates in the fourth mode.

20. A memory system, comprising:
a non-volatile storage including a plurality of memory blocks, each memory block including a plurality of memory cells; and
a controller configured to determine a storage mode indicating how many bit data is stored in a memory cell, based at least on a parameter including usage count regarding a memory block including the memory cell, calculate a storage capacity of the memory block based on the storage mode, and notify the storage capacity to an external device.
